(19) United States
(12) Patent Application Publication
(10) Pub. No.: US 2019/0164078 A1
(43) Pub. Date: May 30, 2019

(54) INFORMATION PROCESSING SYSTEM, INFORMATION PROCESSING METHOD, AND RECORDING MEDIUM

(71) Applicant: NEC Corporation, Minato-ku, Tokyo (JP)

(72) Inventors: Daniel Georg ANDRADE SILVA, Tokyo (JP); Itaru HOSOMI, Tokyo (JP)

(73) Assignee: NEC Corporation, Minato-ku, Tokyo (JP)

(21) Appl. No.: 16/092,542

(22) PCT Filed: Apr. 13, 2017
(86) PCT No.: PCT/JP2017/015078

§ 371 Date: Oct. 10, 2018

(30) Foreign Application Priority Data
Apr. 22, 2016 (JP) 2016-085795

(51) Int. Cl. G06N 20/00; G06N 7/02

(52) U.S. Cl. CPC G06N 20/00; G06K 9/6257; G06N 7/02

(57) ABSTRACT

Provided is an information processing system to accurately predict performance of a classifier to the number of samples of labeled data. A training system 100 includes an extraction unit 120 and an estimation unit 130. The extraction unit 120 extracts a reference data set that is similar to a target data set, from one or more reference data sets. The estimation unit 130 estimates a performance of a classifier assuming that the classifier is trained with labeled data in the target data set, by using the extracted reference data set, and outputs the estimated performance.

### TECHNICAL FIELD

The present invention relates to an information processing system, an information processing method, and a recording medium.

### BACKGROUND ART

A classifier for classifying texts and images is trained by using training data to which labels are given. It is known that, as the number of samples of labeled training data becomes larger, performance of the classifier generally becomes better. However, since such labels are given by a person for example, increasing the number of samples of labeled training data leads to increase in cost. For this reason, in order to obtain desired performance, it is necessary to know how many samples of data need to be labeled in addition to the current number of samples of labeled data. Particularly in active learning, labels are given (annotation is performed) by selecting data which may lead to improvement in performance of the classifier. It is necessary to know an improvement of performance of the classifier for the increased number of samples of labeled data, in order to determine whether to continue the annotation.

As a technique related to estimation of an improvement of performance of a classifier, NPL 1 discloses a method of selecting, from a plurality of active learning algorithms, an active learning algorithm that maximizes accuracy.

### CITATION LIST

### Non Patent Literature

[NPL1] Yoram Baram, et al., “Online Choice of Active Learning Algorithms”, Proceedings of the Twentieth International Conference on Machine Learning (ICML-2003), 2003.

### SUMMARY OF INVENTION

### Technical Problem

However, in the technique described in above-described NPL 1, an improvement of performance of a classifier is estimated based on information on data set (corpus) to be classified. For this reason, an improvement of performance can be predicted in a case that the increased number of samples of labeled data is small. However, there is an issue that it is difficult to accurately predict an improvement of performance in a case that the increased number of samples of labeled data is large. For example, it is assumed that 350 samples of labeled data exist in a data set to be classified, and it is intended to increase the number of samples of labeled data to 1000. In this case, according to the technique of NPL 1, it is difficult to predict whether accuracy of a classifier increases depending on the number of samples of labeled data or reaches a constant value at the number of a certain degree.

An example object of the present invention is to provide an information processing system, an information processing method, and a recording medium that are capable of solving the above-described problem and accurately predicting performance of a classifier to the number of samples of labeled data.

### Solution to Problem

An information processing system according to an exemplary aspect of the present invention includes: extraction means for extracting a reference data set that is similar to a target data set, from one or more reference data sets; and estimation means for estimating a performance of a classifier assuming that the classifier is trained with labeled data in the target data set, by using the extracted reference data set, and outputting the estimated performance.

An information processing method according to an exemplary aspect of the present invention includes: extracting a reference data set that is similar to a target data set, from one or more reference data sets; and estimating a performance of a classifier assuming that the classifier is trained with labeled data in the target data set, by using the extracted reference data set, and outputting the estimated performance.

A computer readable storage medium according to an exemplary aspect of the present invention records thereon a program causing a computer to perform a method including: extracting a reference data set that is similar to a target data set, from one or more reference data sets; and estimating a performance of a classifier assuming that the classifier is trained with labeled data in the target data set, by using the extracted reference data set, and outputting the estimated performance.

### Advantageous Effects of Invention

An advantageous effect of the present invention is to accurately predict performance of a classifier to the number of samples of labeled data.

### BRIEF DESCRIPTION OF DRAWINGS

FIG. 1 is a block diagram illustrating a characteristic configuration of an example embodiment of the present invention.

FIG. 2 is a block diagram illustrating a configuration of a training system 100, according to the example embodiment of the present invention.

FIG. 3 is a block diagram illustrating a configuration of the training system 100 implemented on a computer, according to the example embodiment of the present invention.

FIG. 4 is a flowchart illustrating operation of the training system 100, according to the example embodiment of the present invention.

FIG. 5 is a diagram illustrating an example of performance curves, according to the example embodiment of the present invention.

FIG. 6 is a diagram illustrating a specific example of performance estimation, according to the example embodiment of the present invention.

FIG. 7 is a diagram illustrating an example of an output screen of an estimated result of performance, according to the example embodiment of the present invention.

### EXAMPLE EMBODIMENT

An example embodiment of the present invention will be described.

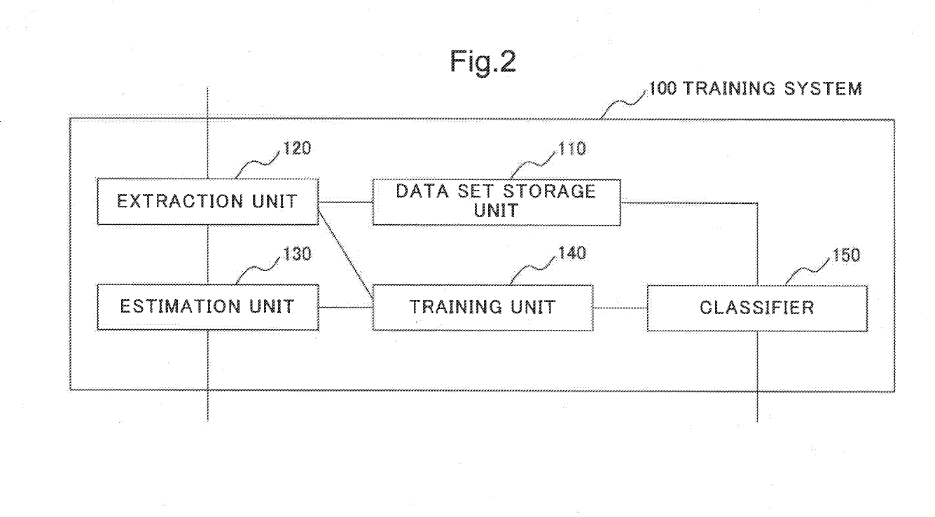

First, a configuration of the example embodiment of the present invention will be described. FIG. 2 is a block diagram illustrating a configuration of a training system 100, according to the example embodiment of the present invention. The training system 100 is one example embodiment of an information processing system of the present invention. Referring to FIG. 2, the training system 100 includes a data set storage unit 110, an extraction unit 120, an estimation unit 130, a training unit 140, and a classifier 150.

The data set storage unit 110 stores one or more data sets. Data (hereinafter, also referred to as an instance) is a target to be classified by the classifier 150, such as a document or text, for example. A data set is a set of one or more samples of data. The data set may be a corpus including one or more documents or texts. As long as a sample of data can be classified by the classifier 150, the data may be data other than a document or a text, such as an image. The data set storage unit 110 stores a data set (hereinafter, also referred to as a target data set) that is a target for which performance of the classifier 150 is to be estimated (a target for performance estimation), and a data set (hereinafter, also referred to as a reference data set) that is used in performance estimation.

In the example embodiment of the present invention, “m” (“m” is an integer of one or more) samples of data have been labeled in a target data set. The training system 100 estimates performance of the classifier 150 assuming that the classifier 150 is trained with “v” (“v” is an integer satisfying “m<v”) samples of labeled data in the target data set. In the reference data set, “n” (“n” is an integer satisfying “v≤n”) samples of data have been labeled.

In addition, in the example embodiment of the present invention, accuracy is used as an index representing performance of the classifier 150. As long as performance of the classifier 150 can be represented, a different index such as precision, recall, an F-score, or the like may be used as an index representing performance.

The extraction unit 120 extracts, from reference data sets in the data set storage unit 110, a reference data set similar to a target data set.

Here, a target data set is defined as D_{T}, a reference data set is defined as Dᵢ (i=1, 2, . . . , N) (N is the number of reference data sets), and a similarity between the target data set D_{T} and the reference data set Dᵢ is defined as s(D_{T}, Dᵢ). In this case, the extraction unit 120 extracts a reference data set similar to the target data set D_{T}, in accordance with equation 1.

D*=arg maxᵢs(D_{T},Dᵢ) [Equation 1]

Examples used as a similarity s(D_{T}, Dᵢ) include a similarity of performance curves (hereinafter, also referred to as training curves or performance characteristics), a similarity of feature vectors, and a similarity of ratios of labels, as expressed below.

1) Similarity of Performance Curves

The extraction unit 120 may uses, as a similarity s(D_{T}, Dᵢ), a similarity of performance curves between the target data set D_{T} and the reference data set Dᵢ, for example. The performance curve is a curve representing performance of the classifier 150 to the number of samples of labeled data used in training of the classifier 150.

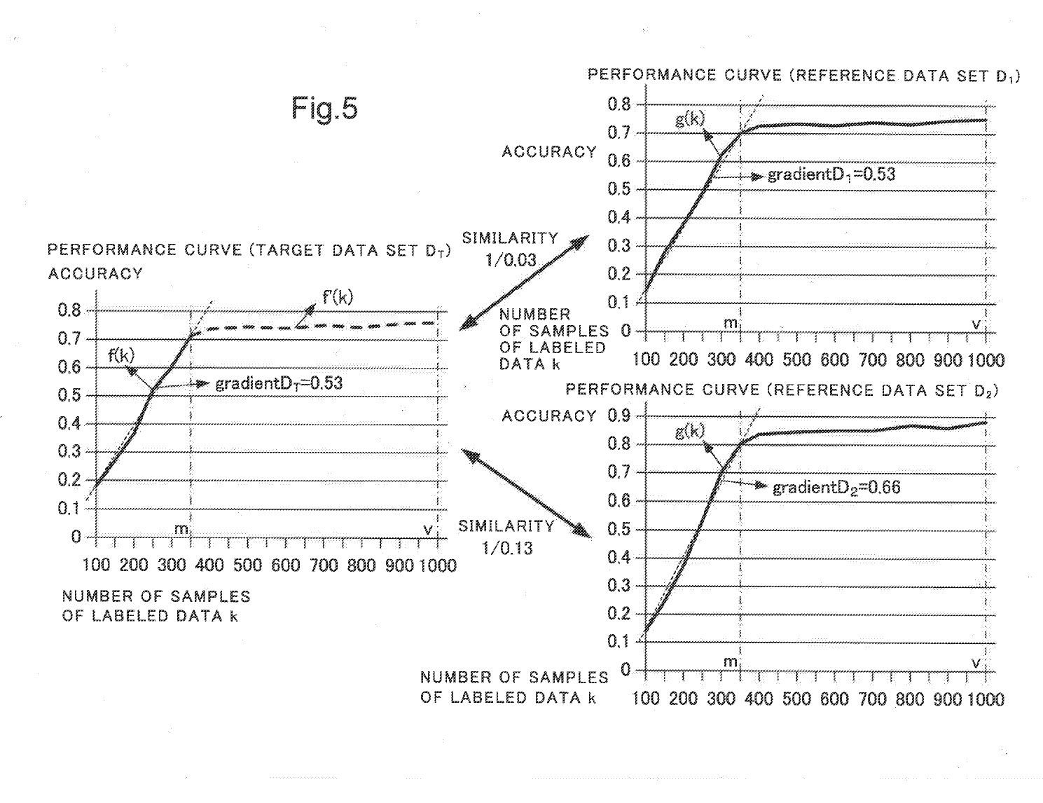

FIG. 5 is a diagram illustrating an example of performance curves according to the example embodiment of the present invention. FIG. 5 illustrates performance curves for the target data set D_{T} and the reference data sets D₁ and D₂.

An example used as a similarity of performance curves is a similarity between a gradient D_{T} and a gradient D₁ or D₂ of the curves in a range where the number of samples of labeled data is equal to or smaller than “m”, as illustrated in FIG. 5. In this case, a similarity s(D_{T}, D₁) is defined by equation 2, for example.

s(D_{T},Dᵢ):=1/|gradientD_{T}−gradientDᵢ| [Equation 2]

As a similarity of performance curves, a similarity of performance values at the number of samples of labeled data “m” may be used.

A performance curve is generated by cross-validation using labeled data selected from a data set, for example. When the leave-one-out method is used as the cross-validation, one sample of data is extracted from selected “k” samples of labeled data, and the training unit 140 described below trains the classifier 150 by using the remaining “k−1” samples of data. Then, a result of classification of the extracted one sample of data by the trained classifier 150 is validated with the given label. By repeating such training, classification, and validation “k” times while changing a sample of data to be extracted, and averaging the results, a performance value for the “k” samples of labeled data is calculated. Note that as the cross-validation, K-fold cross-validation other than the leave-one-out method may be used.

The “k” samples of labeled data in generation of the performance curve are selected in the same method as a method of selecting samples of data to be labeled when training the classifier 150 for which performance is to be estimated. In other words, when samples of data to be labeled are randomly selected at the time of training, “k” samples of labeled data are randomly selected also in generation of a performance curve. When samples of data to be labeled are selected by active learning at the time of training, “k” samples of labeled data are selected in accordance with the same active learning method also in generation of a performance curve. Examples used as the active learning method include the uncertainty sampling and the query-by-committee, which use, as an index, the least confident, the margin sampling, the entropy, or the like. When the active learning is used, “k′ (k′ >k)” samples of labeled data are acquired by selecting “k′−k” samples of data in addition to the already selected “k” samples of data.

2) Similarity of Feature Vectors

The extraction unit 120 may use, as a similarity s(D_{T}, Dᵢ), a similarity of feature vectors of data groups to which the same labels are given respectively (data groups for respective labels), between the target data set D_{T} and the reference data set Dᵢ. For example, the labels {A1, A2} have been given to samples of labeled data in the target data set D_{T}, and the labels {B1, B2} have been given to samples of labeled data in the reference data set D₁. In this case, a similarity s(D_{T}, Dᵢ) is defined by equation 3, for example.

s(D_{T},Dᵢ)=max{su(D_{T}_{_}_{A1},Dᵢ_{_}_{B1})+su(D_{T}_{_}_{A2},Dᵢ_{_}_{B2}),su(D_{T}_{_{—A1}},Dᵢ_{_}_{B2})+su(D_{T}_{_}_{A2},Dᵢ_{_}_{B1})} [Equation 3]

Here, D_{T}_{_}_{A1} and D_{T}_{_}_{A2} indicate, among samples of data in the target data set D_{T}, data groups to which the labels A1 and A2 have been given respectively. Similarly, Dᵢ_{_}_{B1} and Dᵢ_{_}_{B2} indicate, among samples of data in the reference data set Dᵢ, data groups to which the labels B1 and B2 have been given respectively. Further, su(Dₓ, D_{y}) is a similarity between the data groups Dₓ and D_{y}, and is defined as in equation 4.

su(Dₓ,D_{y}):=cos_sim(hist(Dₓ),hist(D_{y})) [Equation 4]

Here, hist(D) is a feature vector of the data group D, and represents distribution of the number of appearances for respective words in the data group D. Further, cos_sim (hist(Dₓ), hist(D_{y})) is a cosine similarity between hist(Dₓ) and hist(D_{y}).

3) Similarity of Label Ratios

The extraction unit 120 may use, as a similarity s(D_{T}, Dᵢ), a similarity of ratios with respect to the numbers of samples of data to which the same labels have been given (the numbers of samples of data for the respective labels), between the target data set D_{T} and the reference data set Dᵢ. For example, when the label indicates a positive example or a negative example for a specific class, a ratio between the numbers of samples of data to which the label of the positive example has been attached and the number of samples of data to which the label of the negative example has been given is used.

Note that even when a similarity of performance curves or feature vectors as described above is used, the extraction unit 120 may use, as the reference data sets Dᵢ, sets where a ratio of the numbers of samples of data, to which the same labels have been given, is the same as or approximately the same as that in the target data set D_{T}. In this case, the extraction unit 120 generates new reference data sets Dᵢ by extracting labeled data from the original reference data sets Dᵢ, in such a way that a ratio of the numbers of samples of data to which the same labels have been given becomes the same as or approximately the same as that in the target data set D_{T}. Then, the extraction unit 120 extracts a reference data set similar to the target data set D_{T}, from the new reference data sets Dᵢ.

The estimation unit 130 estimates performance of the classifier 150 assuming the classifier 150 is trained with “v” (“v” is an integer satisfying “m<v”) samples of labeled data in the target data set, by using the reference data set extracted by the extraction unit 120.

Here, for example, the estimation unit 130 generates a performance curve f(k) in a range up to the number of samples of labeled data “m” in the target data set D_{T} in accordance with the above-described method for generating a performance curve, and acquires a performance value f(m) at the number of samples of labeled data “m”. Similarly, the estimation unit 130 generates a performance curve g(k) (k≤n) in a range up to the number of samples of labeled data “n” in the extracted reference data set in accordance with the above-described method for generating a performance curve. Then, the estimation unit 130 generates an estimated performance curve f′(k) (m≤k≤n) for the target data set D_{T} by equation 5, and acquires an estimated performance value f′(v) at the number of samples of labeled data “v”.

f′(k)=f(m)+(g(k)−g(m)), for m≤k≤n [Equation 5]

The estimation unit 130 outputs (displays) the estimated result of performance (the estimated performance value for the number of samples of the labeled data “v”) to a user or the like via an output device 104.

Note that the extraction unit 120 and the estimation unit 130 may store, in a storage unit (not illustrated), generated performance curves of the target data set D_{T} and the reference data set Dᵢ, together with the method for selecting samples of labeled data used at the time of the generation. In this case, when the performance curves to be generated are already stored, the extraction unit 120 or the estimation unit 130 may calculate a similarity or estimate a performance value, by using the stored performance curves.

The training unit 140 trains the classifier 150 for the target data set D_{T} or the reference data set Dᵢ, when the extraction unit 120 or the estimation unit 130 generates a performance curve as described above. A user or the like designates the number of samples of labeled data for acquiring desired performance, based on the estimated result of performance, and instructs training of the classifier 150. The training unit 140 trains the classifier 150, by using the number of samples of labeled data in the target data set D_{T}, designated by the user or the like. The training unit 140 trains the classifier 150 while selecting, at random or by active learning, the designated number of samples of data to which labels are to be given.

The classifier 150 is trained with samples of labeled data included in the target data set D_{T} or the reference data set Dᵢ, and classifies samples of data in the target data set D_{T} or the reference data set Dᵢ.

Note that the training system 100 may be a computer that includes a central processing unit (CPU) and a storage medium storing a program, and operates under control based on the program.

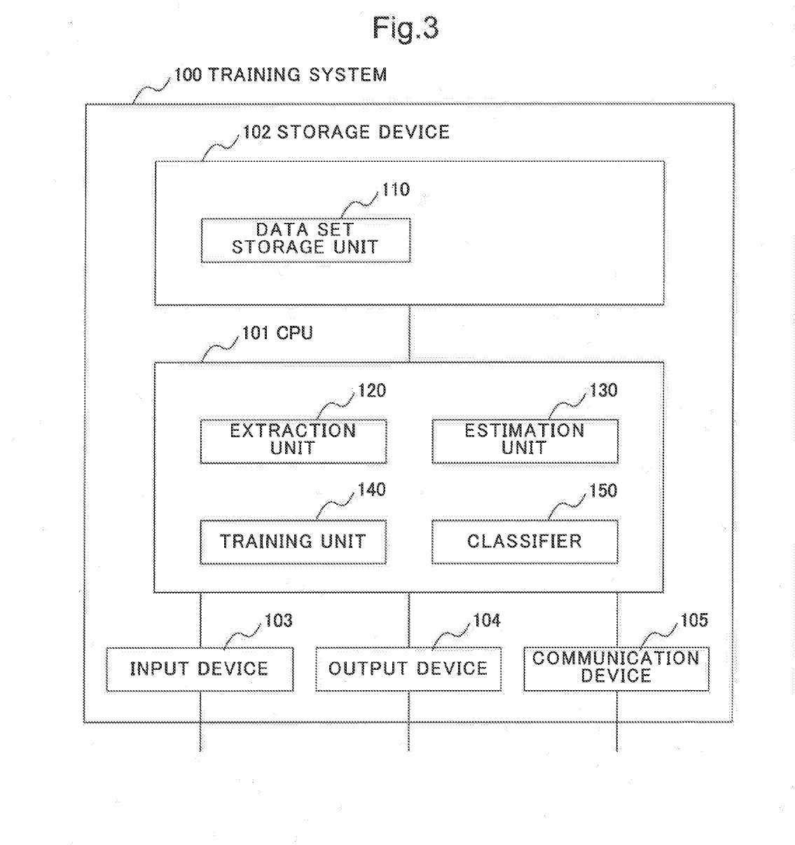

FIG. 3 is a block diagram illustrating a configuration of a training system 100 implemented on a computer, according to the example embodiment of the present invention.

In this case, the training system 100 includes a CPU 101, a storage device 102 (storage medium) such as a hard disk or a memory, an input device 103 such as a keyboard, an output device 104 such as a display, and a communication device 105 communicating with another device or the like. The CPU 101 executes a program for implementing the extraction unit 120, the estimation unit 130, the training unit 140, and the classifier 150. The storage device 102 stores data (data sets) of the data set storage unit 110. The input device 103 receives, from a user or the like, instructions for performance estimation and training, and input of labels to be given to data. The output device 104 outputs (displays) an estimated result of performance to the user or the like. Alternatively, the communication device 105 may receive, from another device or the like, instructions for performance estimation and training, and labels. The communication device 105 may output an estimated result of performance to another device or the like. The communication device 105 may receive the target data set and the reference data set from another device or the like.

A part or all of the respective constituent elements of the training system 100 may be implemented on multipurpose or dedicated circuitry, a processor, or the like, or a combination thereof. These may be configured by a single chip, or may be configured by a plurality of chips connected via a bus. A part or all of the respective constituent elements may be implemented on a combination of the above-described circuitry or the like and the program.

When a part or all of the respective constituent elements of the training system 100 are implemented on a plurality of computers, pieces of circuitry, or the like, the plurality of computers, pieces of circuitry, or the like may be centralizedly arranged or may be distributedly arranged. For example, the plurality of computers, pieces of circuitry, or the like may be implemented as a form of being connected to each other via a communication network such as a client-and-server system or a cloud computing system.

Next, operation of the example embodiment of the present invention will be described.

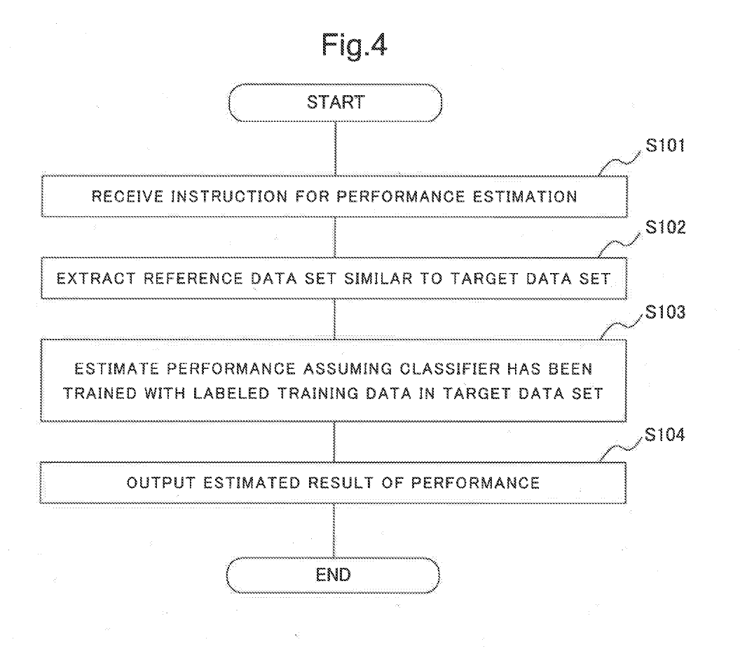

FIG. 4 is a flowchart illustrating the operation of the training system 100 according to the example embodiment of the present invention.

First, the training system 100 receives an instruction for performance estimation, from a user or the like (step S101). In this step, the training system 100 receives input of an identifier of a target data set, and the number of samples of labeled data “v” for which performance is to be estimated.

The extraction unit 120 of the training system 100 extracts a reference data set similar to the target data set from reference data sets in the data set storage unit 110 (step S102).

The estimation unit 130 estimates performance of the classifier 150 assuming the classifier 150 has been trained with labeled training data in the target data set, by using the reference data set extracted by the extraction unit 120 (step S103). In this step, the estimation unit 130 estimates performance of the classifier 150 assuming that the classifier 150 has been trained with “v” samples of labeled training data.

The estimation unit 130 outputs (displays) the estimated result of performance of the classifier 150 to a user or the like through the output device 104 (step S104).

By the above, the operation of the example embodiment of the present invention is completed.

In the example embodiment of the present invention, performance is estimated, when a target data set includes “m” samples of labeled data, assuming the number of samples of labeled data has been increased to “v”. Alternatively, without limitation to this, performance may be estimated, when a target data set includes no samples of labeled data, assuming the number of samples of labeled data has been set to “v”. In this case, the extraction unit 120 extracts a reference data set similar to the target data set D_{T}, by using a similarity s(D_{T}, Dᵢ) defined by equation 6, for example.

s(D_{T},Dᵢ):=su(D_{T},Dᵢ) [Equation 6]

Then, the estimation unit 130 generates a performance curve g(k) for the reference data set, using the reference data set extracted by the extraction unit 120, and acquires g(v) as an estimated performance value at the number of samples of labeled data “v”.

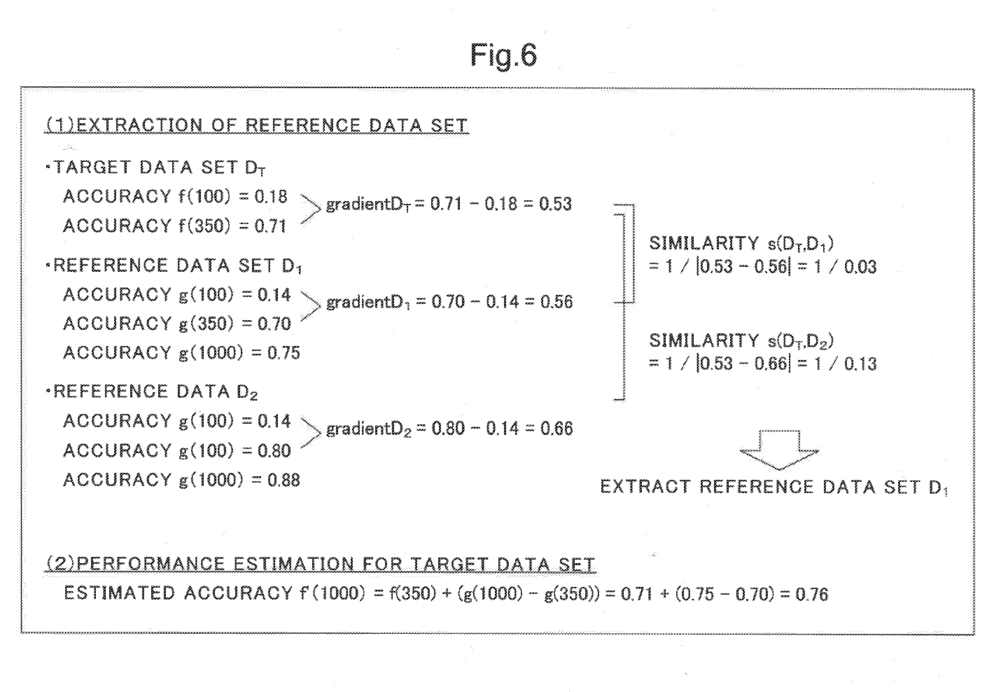

Next, a specific example of the example embodiment of the present invention will be described. FIG. 6 is a diagram illustrating a specific example of performance estimation according to the example embodiment of the present invention. Here, the data set storage unit 110 stores the target data set D_{T} and the reference data sets D₁ and D₂. The number of samples of labeled data “m” in the target data set D_{T} is 350, and the number of samples of labeled data “v” for which estimation is performed is 1000. The number of samples of labeled data in each of the reference data sets D₁ and D₂ “n” is also 1000. In training the classifier 150 for the target data set D_{T}, active learning with the uncertainty sampling using entropy as an index is used.

When a similarity of performance curves is used as a similarity s(D_{T}, Dᵢ), the extraction unit 120 generates a performance curve f(k) for the target data set D_{T}, and performance curves g(k) for the reference data sets D₁ and D₂, in a range up to the number of samples of labeled data “m”, as illustrated in FIG. 5. Here, the extraction unit 120 selects samples of labeled data with the uncertainty sampling using entropy, and generates the performance curves. Then, the extraction unit 120 calculates a gradient D_{T} and gradients D₁ and D₂, and calculates similarities s(D_{T}, Dᵢ), as illustrated in FIG. 6. The extraction unit 120 extracts the reference data set D₁ having a large similarity s(D_{T}, Dᵢ), as a reference data set similar to the target data set D_{T}.

The estimation unit 130 generates the performance curve g(k) for the reference data set D₁, as illustrated in FIG. 5, and generates an estimated performance curve f′(k) for the target data set D_{T}. Then, the estimation unit 130 calculates an estimated performance value (estimation accuracy) “f′(v)=0.76” at the number of samples of labeled data “v” in the target data set D_{T}, as illustrated in FIG. 6.

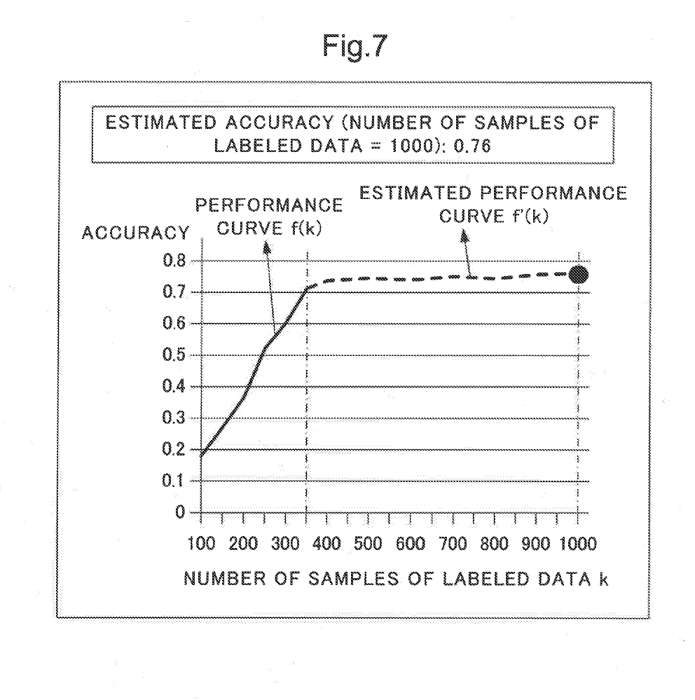

FIG. 7 is a diagram illustrating an example of an output screen of an estimated result of performance according to the example embodiment of the present invention. In the example of FIG. 7, the performance curve f(k) and the estimated performance curve f′(k) for the target data set D_{T}, and the estimated performance value (estimation accuracy) “f′(v)=0.76” at the number of samples of labeled data “v=1000” are illustrated. The estimation unit 130 outputs the output screen of FIG. 7, for example.

Next, a characteristic configuration of an example embodiment of the present invention will be described.

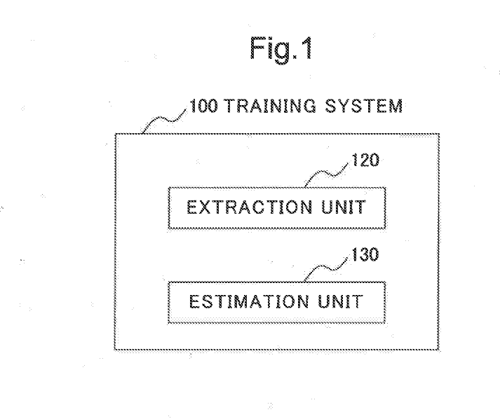

FIG. 1 is a block diagram illustrating a characteristic configuration of an example embodiment of the present invention. Referring to FIG. 1, a training system 100 includes an extraction unit 120 and an estimation unit 130. The extraction unit 120 extracts a reference data set that is similar to a target data set, from one or more reference data sets. The estimation unit 130 estimates a performance of a classifier assuming that the classifier is trained with labeled data in the target data set, by using the extracted reference data set, and outputs the estimated performance.

Next, advantageous effects of the example embodiment of the present invention will be described.

According to the example embodiment of the present invention, it is possible to accurately predict performance of the classifier to the number of samples of labeled data. The reason is that the extraction unit 120 extracts a reference data set similar to a target data set, and the estimation unit 130 estimates performance of the classifier 150 assuming the classifier 150 is trained with labeled data in the target data set, by using the extracted reference data set.

Further, according to the example embodiment of the present invention, it is possible to accurately predict an improvement of performance of the classifier in a case that the increased number of samples of labeled data is large. The reason is that the estimation unit 130 estimates performance of the classifier 150 as follows. The estimation unit 130 uses a performance characteristic at the first number of samples of labeled data with respect to the target data set, and a performance characteristic in a range from the first number to the second number of samples of labeled data with respect to the extracted reference data set. Then, by using these performance characteristics, the estimation unit 130 estimates performance of the classifier 150 assuming the classifier 150 has been trained with the second number of samples of labeled data in the target data set.

While the present invention has been particularly shown and described with reference to the example embodiments thereof, the present invention is not limited to the embodiments. It will be understood by those of ordinary skill in the art that various changes in form and details may be made therein without departing from the spirit and scope of the present invention as defined by the claims.

This application is based upon and claims the benefit of priority from Japanese patent application No. 2016-085795, filed on Apr. 22, 2016, the disclosure of which is incorporated herein in its entirety by reference.

### REFERENCE SIGNS LIST

100 Training system
101 CPU
102 Storage device
103 Input device
104 Output device
105 Communication device
110 Data set storage unit
120 Extraction unit
130 Estimation unit
140 Training unit
150 Classifier

What is claimed is:

1. An information processing system comprising:
a memory storing instructions; and
one or more processors configured to execute the instructions to:
extract a reference data set that is similar to a target data set, from one or more reference data sets; and
estimate a performance of a classifier assuming that the classifier is trained with labeled data in the target data set, by using the extracted reference data set, and output the estimated performance.

2. The information processing system according to claim 1, wherein
the one or more processors is configured to execute the instructions to:
estimate the performance of the classifier assuming that the classifier is trained with labeled data in the target data set, by using a performance characteristic representing a performance, when the classifier is trained with labeled data in the extracted reference data set, to a number of samples of labeled data in the extracted reference data set.

3. The information processing system according to claim 2, wherein
the target data set includes a first number of samples of labeled data, and each of the one or more reference data sets includes a second number of samples of labeled data, the second number being larger than the first number, and,
the one or more processors is configured to execute the instructions to:
when estimating the performance of the classifier, estimate a performance of the classifier assuming that the classifier is trained with the second number of samples of labeled data in the target data set, by using a performance when the classifier is trained with the first number of samples of labeled data in the target data set, the performance being acquired from a performance characteristic with respect to the target data set, and a performance when the classifier is trained with the first number of samples of labeled data in the extracted reference data set and a performance when the classifier is trained with the second number of samples of labeled data in the extracted reference data set, the performances being acquired from a performance characteristic with respect to the extracted reference data set.

4. The information processing system according to claim 1, wherein
the one or more processors is configured to execute the instructions to:
extract the reference data set that is similar to the target data set, based on a similarity between a performance characteristic to a number of samples of labeled data in the target data set and a performance characteristic to a number of samples of labeled data in each of the one or more reference data sets.

5. The information processing system according to claim 1, wherein
the one or more processors is configured to execute the instructions to:
extract the reference data set that is similar to the target data set, based on a similarity between a feature vector of data group for each of labels in the target data set and a feature vector of data group for each of labels in each of the one or more reference data sets.

6. The information processing system according to claim 1, wherein,
the one or more processors is configured to execute the instructions to:
when extracting the reference data set, generate one or more new reference data sets by extracting labeled data from each of the one or more reference data sets in such a way that a ratio of numbers of samples of data for respective labels in the extracted labeled data is the same as or approximately the same as a ratio of numbers of samples of data for respective labels in the target data set, and extract the reference data set that is similar to the target data set from the one or more new reference data sets.

7. The information processing system according to claim 1, wherein
the one or more processors is configured to execute the instructions to:
extract the reference data set that is similar to the target data set, based on a similarity between a ratio of numbers of samples of data for respective labels in the target data set and a ratio of numbers of samples of data for respective labels in each of the one or more reference data sets.

8. An information processing method comprising:
extracting a reference data set that is similar to a target data set, from one or more reference data sets; and
estimating a performance of a classifier assuming that the classifier is trained with labeled data in the target data set, by using the extracted reference data set, and outputting the estimated performance.

9. A non-transitory computer readable storage medium recording thereon a program causing a computer to perform a method comprising:
extracting a reference data set that is similar to a target data set, from one or more reference data sets; and
estimating a performance of a classifier assuming that the classifier is trained with labeled data in the target data set, by using the extracted reference data set, and outputting the estimated performance.
